(19) United States
(12) Patent Application Publication
(10) Pub. No.: US 2025/0328998 A1
(43) Pub. Date: Oct. 23, 2025

(54) MASKED LATENT DECODER FOR IMAGE INPAINTING

(71) Applicant: ADOBE INC., SAN JOSE, CA (US)

(72) Inventors: Haitian Zheng, San Jose, CA (US); Zhifei Zhang, San Jose, CA (US); Zhe Lin, Clyde Hill, WA (US); Yuqian Zhou, Bellevue, WA (US)

(21) Appl. No.: 18/957,817

(22) Filed: Nov. 24, 2024

Related U.S. Application Data
(60) Provisional application No. 63/637,771, filed on Apr. 23, 2024.

(51) Int. Cl. G06T 5/77; G06T 5/60

(52) U.S. Cl. CPC G06T 5/77; G06T 5/60; G06T 2207/20081; G06T 2207/20084

(57) ABSTRACT

A method, apparatus, non-transitory computer readable medium, and system for image processing include obtaining an input image and an input mask, where the input image depicts a scene and the input mask indicates an inpainting region of the input image. A latent code is generated, using a generator network of an image generation model, based on the input image and the input mask. The latent code includes synthesized content in the inpainting region. A synthetic image is generated, using a decoder network of the image generation model, based on the latent code and the input image. The synthetic image depicts the scene from the input image outside the inpainting region and includes the synthesized content within the inpainting region, and the synthetic image comprises a seamless transition across a boundary of the inpainting region.

### CROSS-REFERENCE TO RELATED APPLICATION

This application claims benefit under 35 U.S.C. § 119 to U.S. Provisional Application No. 63/637,771, filed on Apr. 23, 2024, in the United States Patent and Trademark Office, the disclosure of which is incorporated by reference herein in its entirety.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, includes the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image processing. Embodiments of the present disclosure include an image generation system configured to obtain an input image and an input mask that indicates an inpainting region of the input image. An image generation model generates a latent code based on the input image and the input mask. A decoder of the image generation model generates a synthetic image based on the latent code and the input image, where the synthetic image includes synthesized content in the inpainting region that is consistent with content from the input image outside the inpainting region. When training a masked latent decoder, latent code augmentation methods include simulating an imperfect latent code generated by a diffusion model so that the simulated latent code can emulate seam mismatch, color inconsistency, and texture discrepancy. In some examples, color augmentation, erosion, dilation, and blurring are applied to an input image and/or an input mask (referred to as image domain augmentation). In some examples, random noise is applied to a latent code to simulate corruption of latent code during diffusion inference process (referred to as latent code augmentation).

A method, apparatus, non-transitory computer readable medium, and system for image processing are described. One or more embodiments of the method, apparatus, non-transitory computer readable medium, and system include obtaining an input image and an input mask, wherein the input image depicts a scene and the input mask indicates an inpainting region of the input image; generating, using a generator network of an image generation model, a latent code based on the input image and the input mask, wherein the latent code includes synthesized content in the inpainting region; and generating, using a decoder network of the image generation model, a synthetic image based on the latent code and the input image, wherein the synthetic image depicts the scene from the input image outside the inpainting region and includes the synthesized content within the inpainting region, and wherein the synthetic image comprises a seamless transition across a boundary of the inpainting region.

A method, apparatus, non-transitory computer readable medium, and system for image processing are described. One or more embodiments of the method, apparatus, non-transitory computer readable medium, and system include obtaining a training set including a training image; generating a training latent code representing the training image with a seam artifact; and training, using the training set and the training latent code, an image generation model to generate a synthetic image without the seam artifact.

An apparatus, system, and method for image processing are described. One or more embodiments of the apparatus, system, and method include a memory component; a processing device coupled to the memory component, the processing device configured to perform operations comprising: obtaining an input image and an input mask, wherein the input image depicts a scene and the input mask indicates an inpainting region of the input image; generating, using a generator network of an image generation model, a latent code based on the input image and the input mask, wherein the latent code includes synthesized content in the inpainting region; and generating, using a decoder network of the image generation model, a synthetic image based on the latent code and the input image, wherein the synthetic image depicts the scene from the input image outside the inpainting region and includes the synthesized content within the inpainting region, and wherein the synthetic image comprises a seamless transition across a boundary of the inpainting region.

### BRIEF DESCRIPTION OF THE DRAWINGS

FIG. 1 shows an example of an image processing system according to aspects of the present disclosure.

FIG. 2 shows an example of a method for conditional media generation according to aspects of the present disclosure.

FIG. 3 shows an example of a method for image processing according to aspects of the present disclosure.

FIG. 4 shows an example of an image processing apparatus according to aspects of the present disclosure.

FIG. 5 shows an example of an image generation model according to aspects of the present disclosure.

FIG. 6 shows an example of a generative adversarial network (GAN) model according to aspects of the present disclosure.

FIG. 7 shows an example of a guided diffusion model according to aspects of the present disclosure.

FIGS. 8 and 9 show examples of methods for training an image generation model according to aspects of the present disclosure.

FIG. 10 shows an example of a method for training a diffusion model according to aspects of the present disclosure.

FIG. 11 shows an example of a step-by-step procedure for training a machine learning model according to aspects of the present disclosure.

FIGS. 12 and 13 show examples of methods for training a GAN according to aspects of the present disclosure.

FIG. 14 shows an example of a computing device for image processing according to aspects of the present disclosure.

### DETAILED DESCRIPTION

The present disclosure describes systems and methods for image processing. Embodiments of the present disclosure include an image generation system configured to obtain an input image and an input mask that indicates an inpainting region of the input image. An image generation model generates a latent code based on the input image and the input mask. A decoder of the image generation model generates a synthetic image based on the latent code and the input image, where the synthetic image includes synthesized content in the inpainting region that is consistent with content from the input image outside the inpainting region. When training a masked latent decoder, latent code augmentation methods include simulating an imperfect latent code generated by a diffusion model so that the simulated latent code can emulate seam mismatch, color inconsistency, and texture discrepancy. In some examples, color augmentation, erosion, dilation, and blurring are applied to an input image and/or an input mask (referred to as image domain augmentation). In some examples, random noise is applied to a latent code to simulate corruption of latent code during diffusion inference process (referred to as latent code augmentation).

Diffusion models are a class of generative neural networks that can be trained to generate new data with features similar to features found in training data. Diffusion models can be used in image synthesis, image completion tasks, etc. However, latent diffusion models face challenges when applied to image inpainting tasks (e.g., integration of generated content with existing image structures). Conventional diffusion models generate latent codes meant to fill missing or removed parts of an image. These diffusion-generated latent codes cannot precisely replicate the exact characteristics of the surrounding pixel regions, such as color, texture, and subtle details. Therefore, imperfect blending of the inpainted region and the surrounding image areas lead to mismatch between inpainted area and original area (e.g., seam mismatching, color inconsistency, and texture discrepancy).

Embodiments of the present disclosure include an image processing system configured to obtain an input image and an input mask that indicates an inpainting region of the input image; generate, using an image generation model, a latent code based on the input image and the input mask; and generate, using a decoder of the image generation model, a synthetic image based on the latent code and the input image. The synthetic image includes synthesized content in the inpainting region that is consistent with content from the input image outside the inpainting region.

Some embodiments, at training time, include obtaining a training set comprising an input image and an input mask; encoding the input image to obtain a latent code; augmenting the latent code by adding a distortion to obtain an augmented latent code; and training, using the training set, a decoder of an image generation model to decode the augmented latent code based on the input image and the input mask. In some examples, the distortion includes random noise.

In some embodiments, obtaining the training set includes obtaining a preliminary image and applying color augmentation to the preliminary image to obtain the input image. Additionally or alternatively, obtaining the training set includes applying erosion to the preliminary image to obtain the input image, applying dilation to the preliminary image to obtain the input image, applying blurring to the preliminary image to obtain the input image, or applying a combination thereof to obtain the input image.

The present disclosure describes systems and methods that improve on conventional image generation models by providing more accurate inpainted images. For example, seam mismatch, color inconsistency, and texture discrepancy are avoided or reduced. By training a masked latent decoder using a combination of image domain augmentation and latent code augmentation methods, an image generation model described in the present disclosure provides a seamless transition between an original region of an image and an inpainted region.

A seamless transition refers to a transition across a boundary of the inpainting region where the original pixel characteristics (e.g., gradients and edge information) align coherently with the characteristics of the newly generated pixels. For example, colors and textures used in the inpainted region can match colors and textures in the region surrounding the inpainted region in the original image. In some cases, a gradient or rate of change of color or texture from the original image is carried into the inpainted region.

To mitigate a seam between a generated region and the original region, training the masked latent decoder involves simulating less-than-perfect latent code generated by a diffusion model. The simulated latent code (the less-than-perfect latent code) can emulate the seam mismatch, color inconsistency and texture discrepancy through applying random color augmentation, random dilation, erosion, and random blurring on an input mask. In some cases, to further augment the latent code, random noise (e.g., Gaussian noise) is added on the latent code to simulate the corruption of latent code introduced by diffusion inference process.

### Image Processing

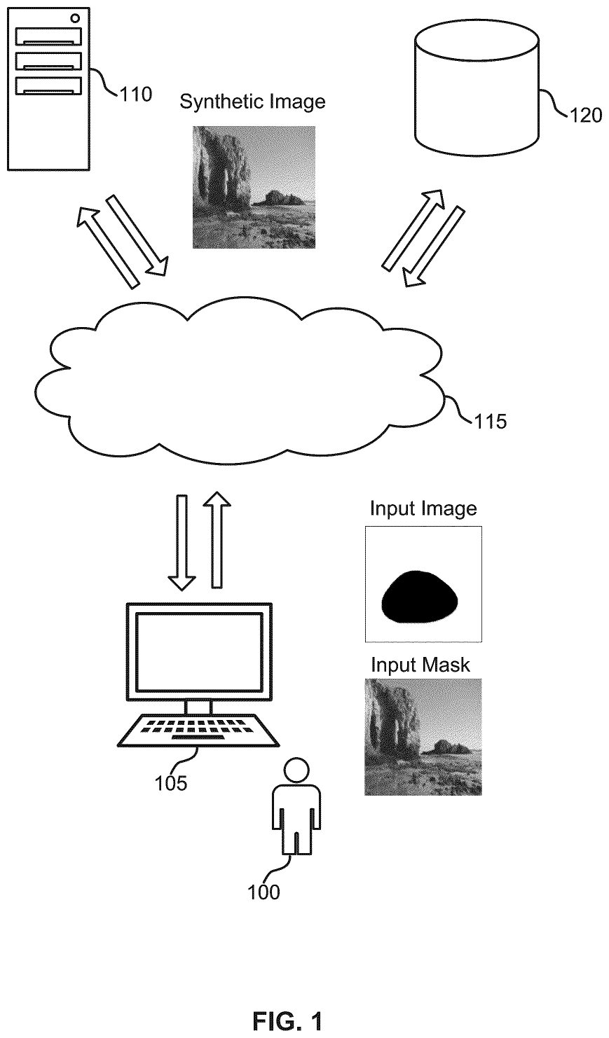

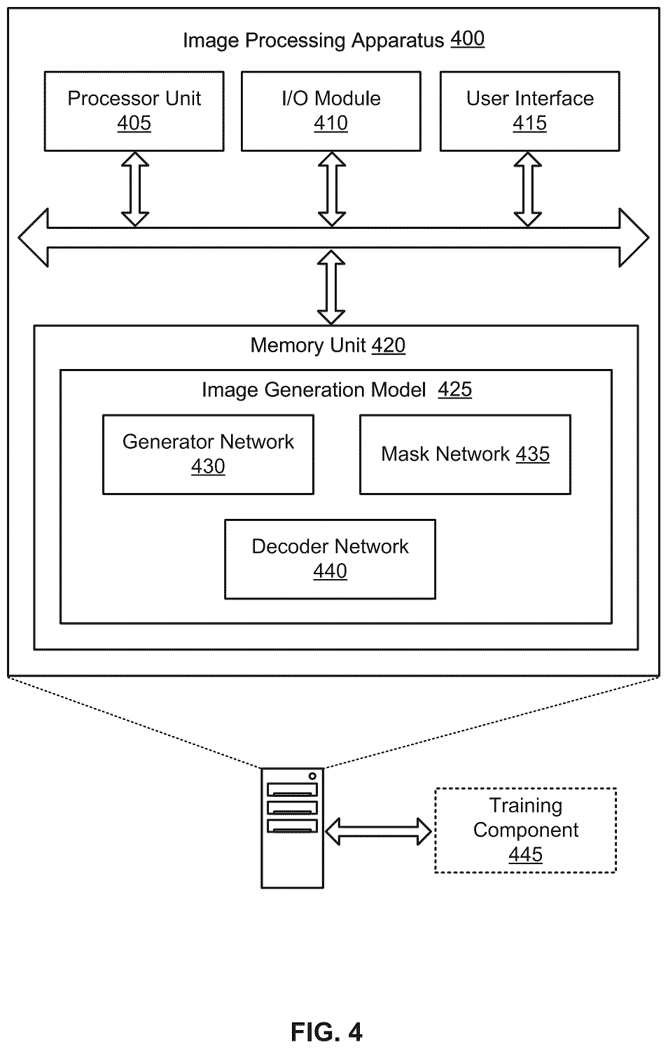

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 4.

In an example shown in FIG. 1, an input image is provided by user 100. An input mask may be provided by user 100 or generated using a mask network based on a user-specified target region to be inpainted or edited. The input image depicts a scene and the input mask indicates an inpainting region of the input image. The input image and the input mask are transmitted to image processing apparatus 110, e.g., via user device 105 and cloud 115.

Image processing apparatus 110 generates, using a generator network of an image generation model, a latent code based on the input image and the input mask, where the latent code includes synthesized content in the inpainting region. Image processing apparatus 110 generates, using a decoder network of the image generation model, a synthetic image based on the latent code and the input image. The synthetic image depicts the scene from the input image outside the inpainting region and includes the synthesized content within the inpainting region. The synthetic image comprises a seamless transition across a boundary of the inpainting region. Image processing apparatus 110 returns the synthetic image to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

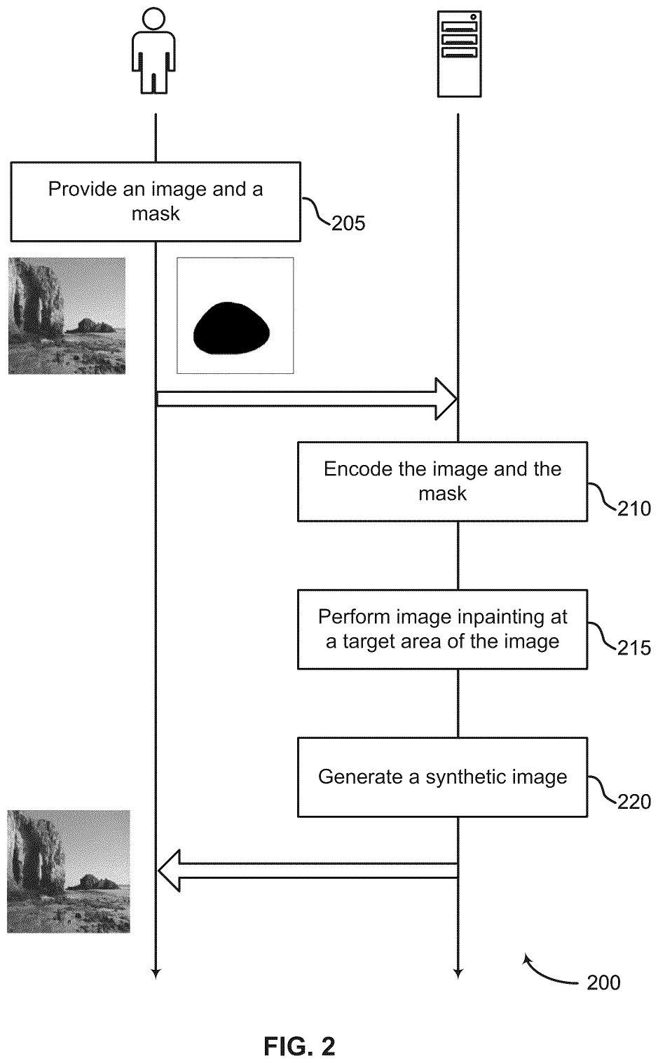

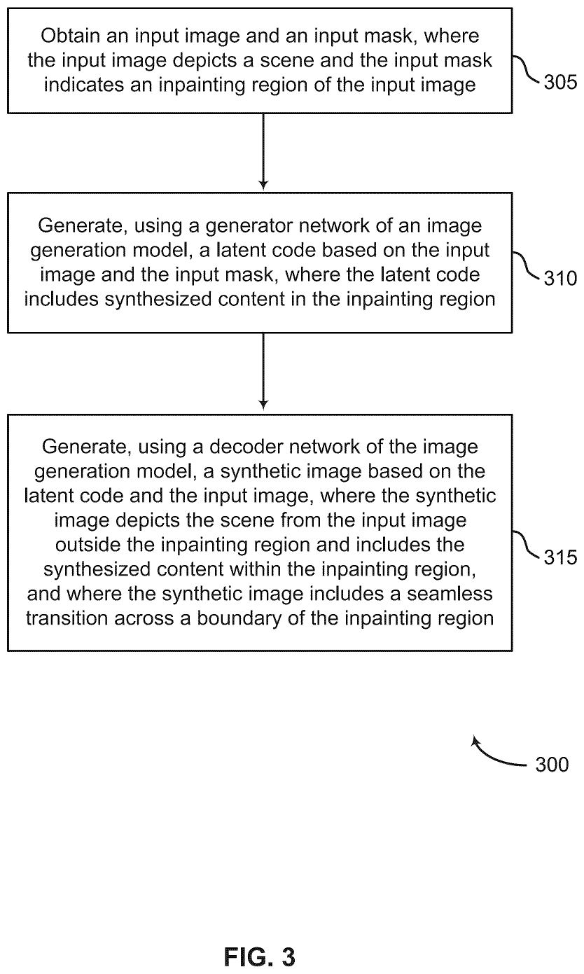

Image processing apparatus 110 includes a computer-implemented network comprising a generator network, a mask network, and a decoder network. Image processing apparatus 110 may also include a processor unit, a memory unit, an I/O module, and a user interface. A training component may be implemented on an apparatus other than image processing apparatus 110. The training component is used to train a machine learning model (as described with reference to FIGS. 4 and 12-13). Additionally, image processing apparatus 110 can communicate with database 120 via cloud 115. In some cases, the architecture of the machine learning model is also referred to as a network or a network model. Further detail regarding the architecture of image processing apparatus 110 is provided with reference to FIGS. 4-7. Further detail regarding the operation of image processing apparatus 110 is provided with reference to FIGS. 2-3.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training an image generation model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

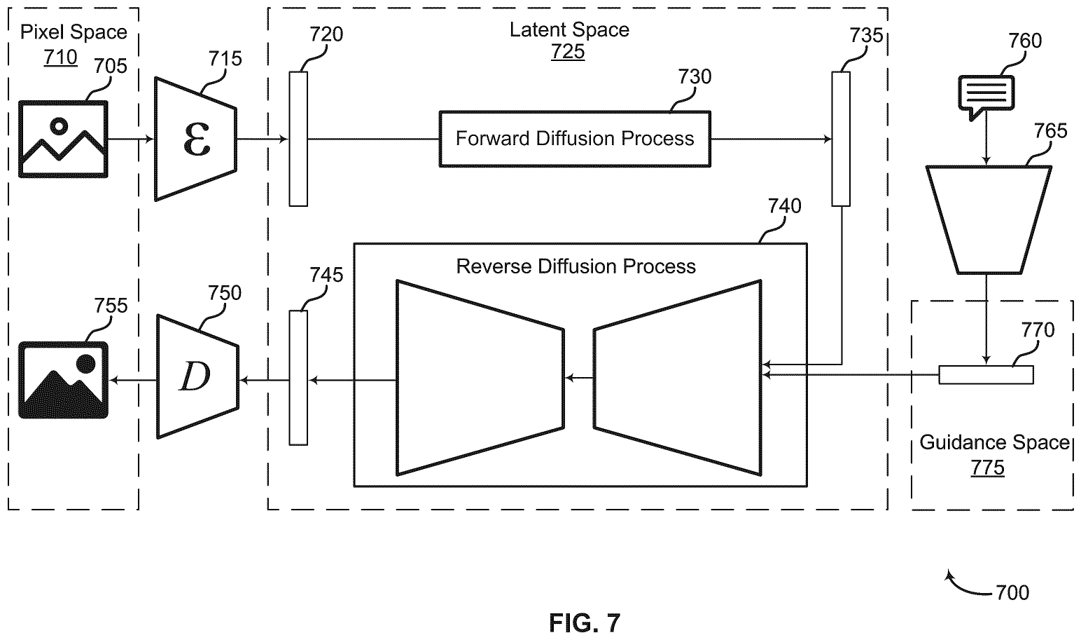

FIG. 2 shows an example of a method 200 for conditional media generation according to aspects of the present disclosure. In some examples, method 200 describes an operation of the image generation model 425 described with reference to FIG. 4 such as an application of the guided latent diffusion model 700 described with reference to FIG. 7. In some examples, these operations are performed by a system including a processor executing a set of codes to control functional elements of an apparatus such as the image processing apparatus described in FIGS. 1 and 4.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

At operation 205, the user provides an image and a mask. In some cases, the operations of this step refer to, or may be performed by, a user as described with reference to FIG. 1. The mask indicates an inpainting region of the input image. In an example, the image provided by the user depicts a scene of a rock cliff by the ocean, and the provided mask indicates a location of a region (in dark color) at the center for inpainting.

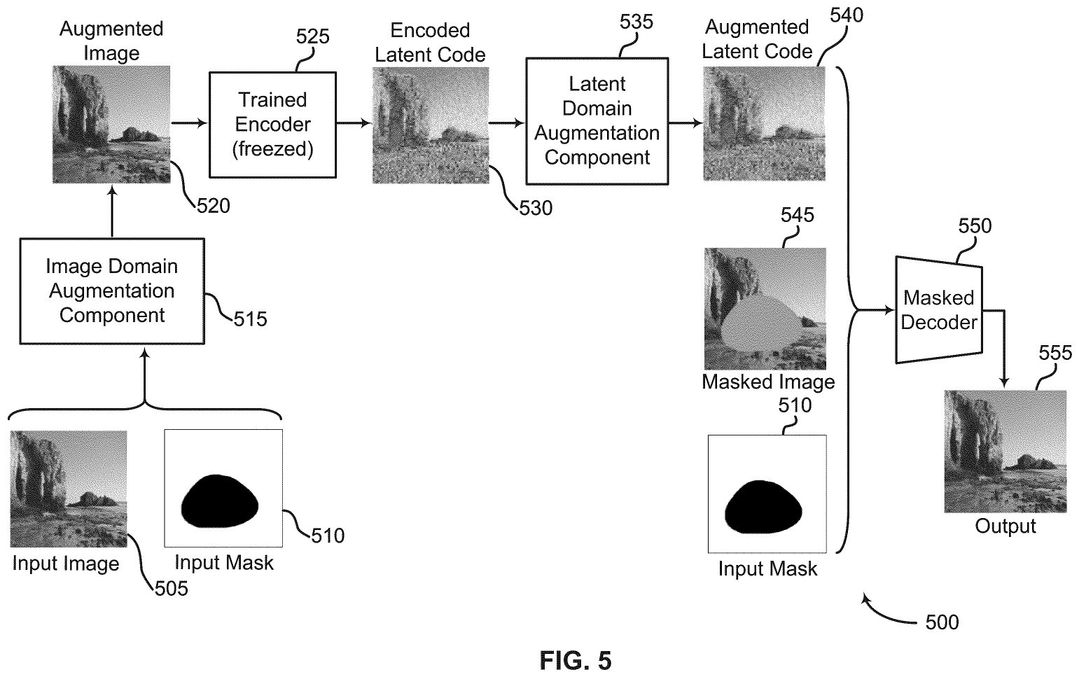

At operation 210, the system encodes the image and the mask. In some cases, the operations of this step refer to, or may be performed by, an image processing apparatus as described with reference to FIGS. 1 and 4. In some embodiments, the image and the mask are encoded into a latent space. This latent encoding may be referred to as a latent code. In some cases, the encoding is performed using trained image encoder. In some embodiments, the latent code is augmented to mimic the corruption of latent code introduced by diffusion inference described in more detail in FIG. 5.

At operation 215, the system performs image inpainting at a target area of the image. In some cases, the operations of this step refer to, or may be performed by, an image processing apparatus as described with reference to FIGS. 1 and 4. In some embodiments, a location of the target area to be inpainted is indicated by the mask.

At operation 220, the system generates a synthetic image. In some cases, the operations of this step refer to, or may be performed by, an image processing apparatus as described with reference to FIGS. 1 and 4. The synthetic image depicts the scene from the image outside the inpainting region and includes synthesized content within the inpainting region. The synthetic image includes a seamless transition across a boundary of the inpainting region. In some cases, the synthetic image is generated using a decoder network of an image generation model. In the above example, the synthetic image depicts the substantially similar scene from the image (a rock cliff by the ocean). The inpainted region is visually similar to the masked area of the image.

FIG. 3 shows an example of a method 300 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 305, the system obtains an input image and an input mask, where the input image depicts a scene, and the input mask indicates an inpainting region of the input image. In some cases, the operations of this step refer to, or may be performed by, an image generation model as described with reference to FIGS. 4-6. In some cases, the input image is augmented by applying random augmentations (e.g., color shift, saturation, hue change, erosion, dilation, blurring, etc.). In some cases, the color augmentation differs between the inpainting region and the rest of the input image.

At operation 310, the system generates, using a generator network of an image generation model, a latent code based on the input image and the input mask, where the latent code includes synthesized content in the inpainting region. In some cases, the operations of this step refer to, or may be performed by, a generator network as described with reference to FIGS. 4, 5, and 12. In some cases, the latent code includes latent information corresponding to the input image and the input mask.

In some embodiments, an encoder such as an autoencoder (e.g., KL-VAE, VQ-VAE) generates the latent code. Here, KL-VAE is short for Kullback-Leibler variational autoencoder. VQ-VAE is short for vector quantized VAE.

At operation 315, the system generates, using a decoder network of the image generation model, a synthetic image based on the latent code and the input image, where the synthetic image depicts the scene from the input image outside the inpainting region and includes the synthesized content within the inpainting region, and where the synthetic image includes a seamless transition across a boundary of the inpainting region. In some cases, the operations of this step refer to, or may be performed by, a decoder network as described with reference to FIGS. 4 and 5. In some cases, the decoder network may also be referred to as a masked decoder or a masked latent decoder.

In an embodiment, the image generation model includes a latent diffusion model. The latent diffusion model, at inference time, generates a latent code (e.g., a feature map) as output. Then the decoder network (i.e., the masked decoder) takes the latent code and an original masked image as inputs. The decoder network generates the synthesized image (i.e., output image) based on the latent code and the original masked image.

In some embodiments, the decoder network (i.e., the masked decoder) and a diffusion model are independently trained. At inference time, the latent diffusion model generates the latent code corresponding to an inpainted image. Then the decoder network takes the latent code as input and decodes the latent code to generate the inpainted image. Embodiments of the present disclosure can be applied to any autoencoder for latent diffusion model. For example, the decoder network can work with KL-VAE and VQ-VAE.

In some examples, the image domain augmentation and latent code augmentation are both performed when training a masked latent decoder. Differences in color, dilation, blurring, and other mismatches between pixels in the inpainting region and the rest of the image are resolved to generate a visually consistent synthetic image. To mitigate the seam, some embodiments simulate the less accurate (less than perfect) latent code generated by a diffusion model. This way, during training, the simulated latent code can emulate the seam mismatch, color inconsistency and texture discrepancy caused by the diffusion model. The process for generating the simulated latent may be referred to as latent code augmentation.

In FIGS. 1-3, a method, apparatus, non-transitory computer readable medium, and system for image processing are described. One or more embodiments of the method, apparatus, non-transitory computer readable medium, and system include obtaining an input image and an input mask, wherein the input image depicts a scene and the input mask indicates an inpainting region of the input image; generating, using a generator network of an image generation model, a latent code based on the input image and the input mask, wherein the latent code includes synthesized content in the inpainting region; and generating, using a decoder network of the image generation model, a synthetic image based on the latent code and the input image, wherein the synthetic image depicts the scene from the input image outside the inpainting region and includes the synthesized content within the inpainting region, and wherein the synthetic image comprises a seamless transition across a boundary of the inpainting region.

Some examples of the method, apparatus, non-transitory computer readable medium, and system further include selecting an inpainting mode, wherein the synthetic image is generated based on the inpainting mode. Some examples of the method, apparatus, non-transitory computer readable medium, and system further include obtaining an input prompt, wherein the synthesized content is based on the input prompt.

Some examples of the method, apparatus, non-transitory computer readable medium, and system further include obtaining a noise map. Some examples further include encoding the input image to obtain an input encoding. Some examples further include denoising the noise map based on the input encoding. In some examples, the image generation model is trained for an inpainting task using a training set including a training latent code representing a seam artifact. Some examples of the method, apparatus, non-transitory computer readable medium, and system further include generating a masked image based on the input image and the input mask, wherein the synthetic image is generated based on the masked image.

### Network Architecture

FIG. 4 shows an example of an image processing apparatus 400 according to aspects of the present disclosure. The example shown includes image processing apparatus 400, processor unit 405, I/O module 410, user interface 415, memory unit 420, image generation model 425, and training component 445. Image processing apparatus 400 is an example of, or includes aspects of, the corresponding element described with reference to FIG. 1.

Image processing apparatus 400 may include an example of, or aspects of, the guided diffusion model described with reference to FIG. 7. In some embodiments, image processing apparatus 400 includes processor unit 405, I/O module 410, user interface 415, memory unit 420, image generation model 425, and training component 445. Training component 445 updates parameters of the image generation model 425 stored in memory unit 420. In some examples, the training component 445 is located outside the image processing apparatus 400.

Processor unit 405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

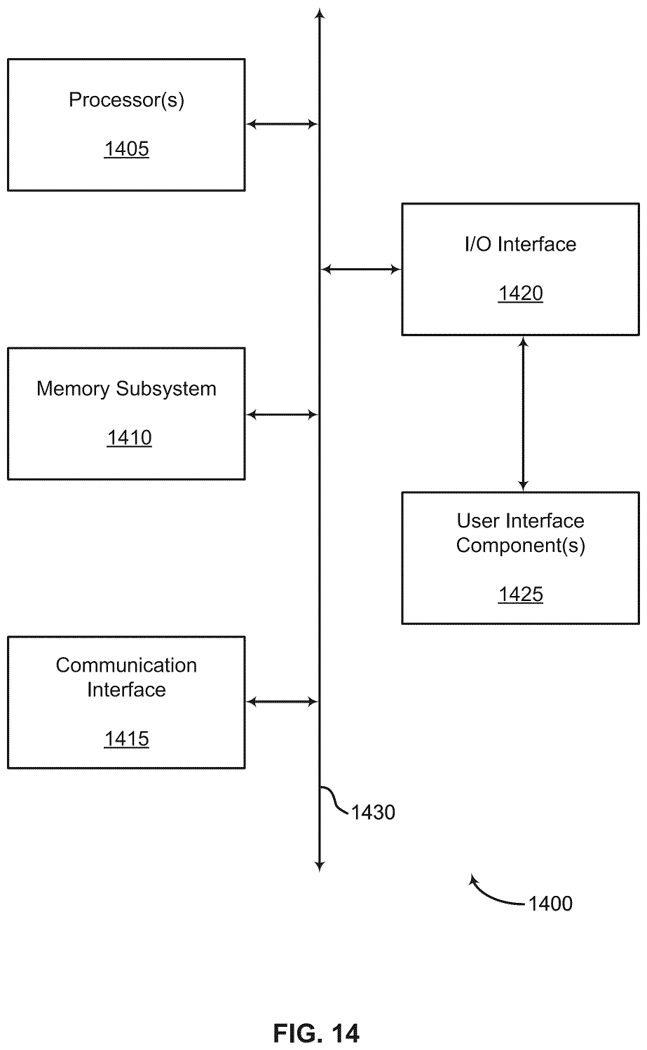

In some cases, processor unit 405 is configured to operate a memory array using a memory controller. In other cases, a memory controller is integrated into processor unit 405. In some cases, processor unit 405 is configured to execute computer-readable instructions stored in memory unit 420 to perform various functions. In some aspects, processor unit 405 includes special-purpose components for modem processing, baseband processing, digital signal processing, or transmission processing. According to some aspects, processor unit 405 comprises one or more processors 1405 described with reference to FIG. 14.

Memory unit 420 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 405 to perform various functions described herein.

In some cases, memory unit 420 includes a basic input/output system (BIOS) that controls basic hardware or software operations, such as an interaction with peripheral components or devices. In some cases, memory unit 420 includes a memory controller that operates memory cells of memory unit 420. For example, the memory controller may include a row decoder, column decoder, or both. In some cases, memory cells within memory unit 420 store information in the form of a logical state. According to some aspects, memory unit 420 is an example of the memory subsystem 1410 described with reference to FIG. 14.

According to some aspects, image processing apparatus 400 uses one or more processors of processor unit 405 to execute instructions stored in memory unit 420 to perform functions described herein. For example, image processing apparatus 400 may obtain an input image and an input mask, where the input image depicts a scene and the input mask indicates an inpainting region of the input image. Image processing apparatus 400 generates, using a generator network 430 of image generation model 425, a latent code based on the input image and the input mask, where the latent code includes synthesized content in the inpainting region. Image processing apparatus 400 generates, using a decoder network 440 of image generation model 425, a synthetic image based on the latent code and the input image. The synthetic image depicts the scene from the input image outside the inpainting region and includes the synthesized content within the inpainting region, and the synthetic image comprises a seamless transition across a boundary of the inpainting region.

The memory unit 420 may include image generation model 425 trained to obtain an input image and an input mask, where the input image depicts a scene and the input mask indicates an inpainting region of the input image; generate, using generator network 430, a latent code based on the input image and the input mask, where the latent code includes synthesized content in the inpainting region; and generate, using decoder network 440, a synthetic image based on the latent code and the input image, where the synthetic image depicts the scene from the input image outside the inpainting region and includes the synthesized content within the inpainting region. The synthetic image comprises a seamless transition across a boundary of the inpainting region. For example, after training, image generation model 425 may perform inferencing operations as described with reference to FIGS. 2-3.

In some embodiments, the image generation model 425 is an artificial neural network (ANN) comprising a guided diffusion model described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted. In some examples, the nodes are aggregated into layers.

The parameters of image generation model 425 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

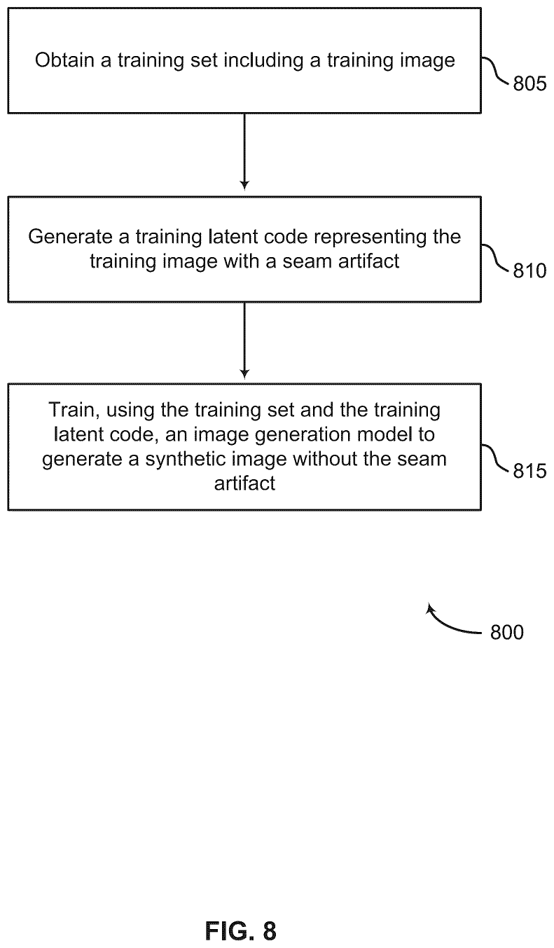

Training component 445 may train the image generation model 425. For example, parameters of the image generation model 425 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 8-13). The goal of the training process may be to find optimal values for the parameters that allow the machine learning model to make accurate predictions or perform well on the given task.

Accordingly, the node weights can be adjusted to increase the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 425 can be used to make predictions on new, unseen data (i.e., during inference).

I/O module 410 receives inputs from and transmits outputs of the image processing apparatus 400 to other devices or users. For example, I/O module 410 receives inputs for the image generation model 425 and transmits outputs of the image generation model 425. According to some aspects, I/O module 410 is an example of the I/O interface 1420 described with reference to FIG. 14.

According to some embodiments, image processing apparatus 400 includes a GAN for image processing, e.g., image inpainting, editing and composition. Generative adversarial networks or GANs are a group of artificial neural networks where two neural networks are trained based on a contest with each other. Given a training set, the network learns to generate new data with similar properties as the training set. For example, a GAN trained on photographs can generate new images that look authentic to a human observer. GANs may be used in conjunction with supervised learning, semi-supervised learning, unsupervised learning, and reinforcement learning. In some embodiments, a GAN includes a generator network and a discriminator network.

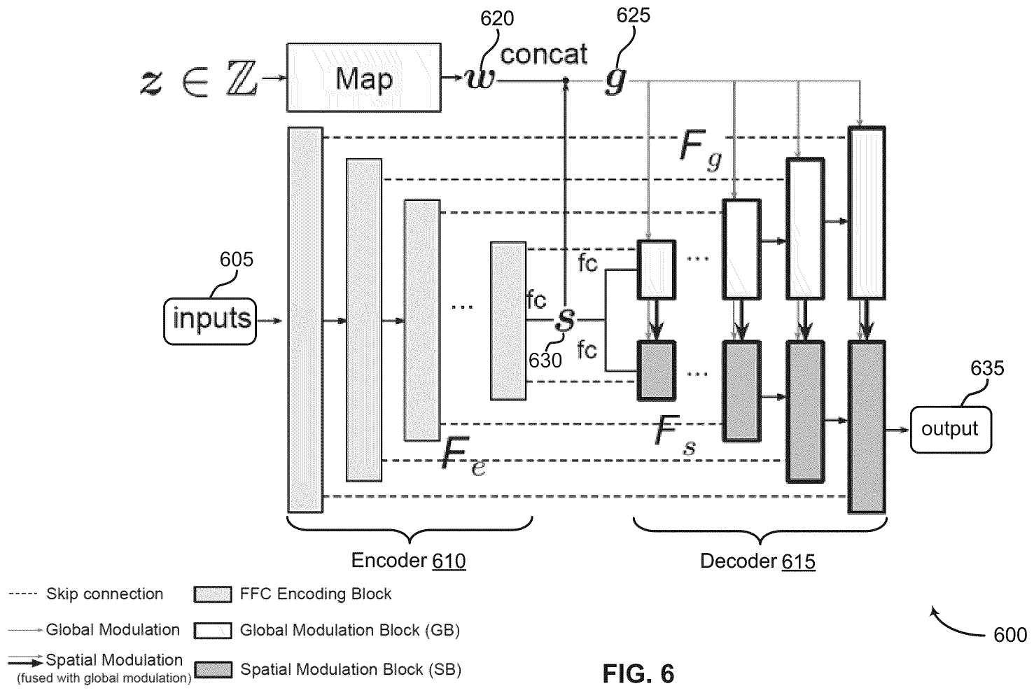

Image generation model 425 is an example of, or includes aspects of, the corresponding element described with reference to FIGS. 5 and 6. In one embodiment, image generation model 425 includes generator network 430, mask network 435, and decoder network 440.

According to some embodiments, image generation model 425 obtains an input image and an input mask, where the input image depicts a scene and the input mask indicates an inpainting region of the input image. In some examples, image generation model 425 obtains a noise map. Image generation model 425 encodes the input image to obtain an input encoding. Image generation model 425 denoises the noise map based on the input encoding.

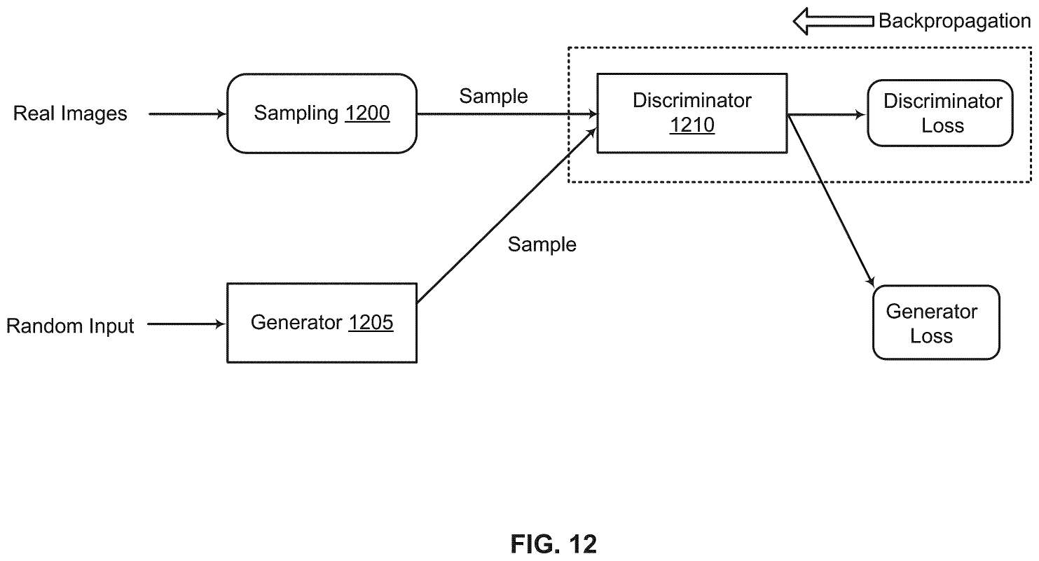

According to some embodiments, generator network 430 generates a latent code based on the input image and the input mask, where the latent code includes synthesized content in the inpainting region. In some examples, generator network 430 includes a latent diffusion model. Generator network 430 is an example of, or includes aspects of, the corresponding element described with reference to FIGS. 5 and 12.

According to some embodiments, decoder network 440 generates a synthetic image based on the latent code and the input image, where the synthetic image depicts the scene from the input image outside the inpainting region and includes the synthesized content within the inpainting region, and where the synthetic image includes a seamless transition across a boundary of the inpainting region. In some examples, decoder network 440 includes a generative adversarial network (GAN). Decoder network 440 is an example of, or includes aspects of, the corresponding element described with reference to FIG. 5.

According to some embodiments, user interface 415 selects an inpainting mode, where the synthetic image is generated based on the inpainting mode. In some examples, user interface 415 obtains an input prompt, where the synthesized content is based on the input prompt.

According to some embodiments, mask network 435 generates a masked image based on the input image and the input mask, where the synthetic image is generated based on the masked image. In some examples, the image generation model 425 is trained for an inpainting task using a training set including a training latent code having a seam artifact.

According to some embodiments, training component 445 obtains a training set including a training latent code having a seam artifact. In some examples, training component 445 trains, using the training set, an image generation model 425 to generate a synthetic image without the seam artifact based on the training latent code. In some examples, training component 445 encodes an image to obtain a preliminary latent code. The training component 445 adds the seam artifact to the preliminary latent code to obtain the training latent code. In some examples, training component 445 adds the seam artifact to an image to obtain an augmented image. The training component 445 encodes the augmented image to obtain the training latent code.

In some examples, the seam artifact includes a random noise distortion, color augmentation, erosion, dilation, blurring, or any combination thereof. In some examples, training component 445 obtains a mask, where the seam artifact is added at a boundary region of the mask. In some examples, training component 445 computes a generative adversarial network (GAN) loss. The training component 445 updates parameters of the image generation model 425 based on the GAN loss.

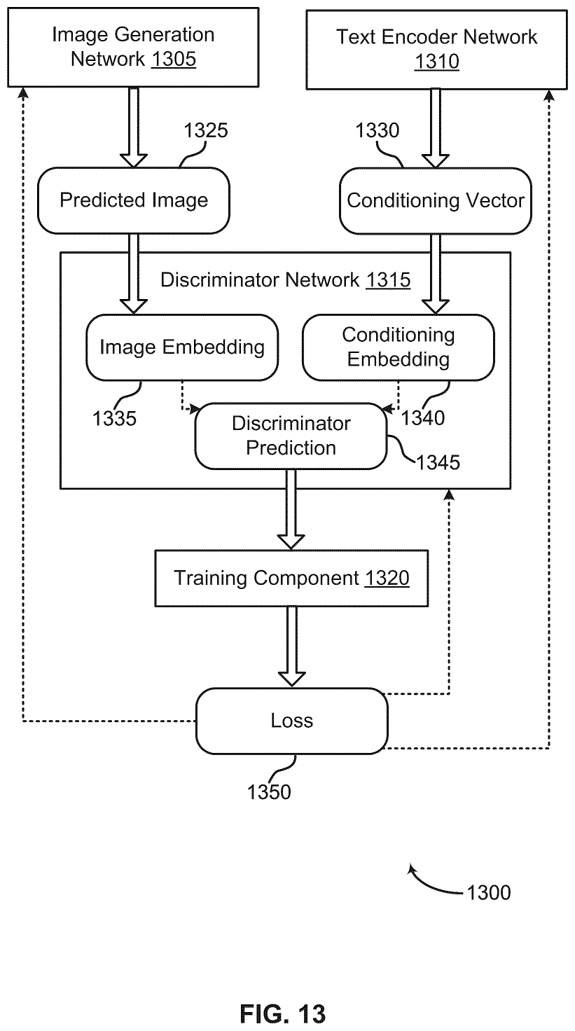

In some examples, training component 445 computes a reconstruction loss. The training component 445 updates parameters of the image generation model 425 based on the reconstruction loss. In some examples, training component 445 computes a perceptual loss. The training component 445 updates parameters of the image generation model 425 based on the perceptual loss. In some examples, training component 445 freezes parameters of generator network 430 of the image generation model 425 while training a decoder network 440 of the image generation model 425. In some examples, image generation model 425 is trained to generate the synthetic image with the seamless transition based on a training latent code having a seam artifact. Training component 445 is an example of, or includes aspects of, the corresponding element described with reference to FIG. 13.

FIG. 5 shows an example of an image generation model 500 according to aspects of the present disclosure. The example shown includes image generation model 500, input image 505, input mask 510, image domain augmentation component 515, augmented image 520, generator network 525, preliminary latent code 530, latent domain augmentation component 535, augmented latent code 540, masked image 545, decoder network 550, and synthetic image 555.

In some examples, image generation model 500 includes a masked latent decoder based on GANs (i.e., decoder network 550). The masked latent decoder is trained to improve the blending of inpainted regions with the original image content. Image generation model 500 can reduce the visibility of seams and improve the overall aesthetic and quality of inpainted images.

In an embodiment, decoder network 550 (also referred to as the masked latent decoder) is trained based on a process of GAN training. The decoder network 550 takes an augmented latent code 540, a masked image 545, and input mask 510 (e.g., a binary mask) for doing latent decoding while blending the original pixels with the decoded region for increased harmonization and seam reduction. To reduce a seam, a training process and method include simulating the imperfect latent code generated by a diffusion model, so that during training, the simulated latent code can emulate the seam mismatch, color inconsistency, and texture discrepancy caused by a diffusion model. In some cases, the process for generating the simulated latent code is referred to as latent code augmentation.

In some embodiments, given an input image 505 and an input mask 510 during training of decoder network 550, latent code augmentation involves generating an augmented latent code 540 that is slightly incoherent to the remaining pixels from the masked image 545. The latent code augmentation includes a process of image domain augmentation via image domain augmentation component 515, encoding via generator network 525, and latent code augmentation via latent domain augmentation component 535.

With regard to image domain augmentation, given an input image 505 and an input mask 510, random color augmentation is applied twice with different random color shifting, saturation, and hue change. The two color-augmented images are composited using the mask in an alpha-blending fashion, so that the composited image has slightly different color for inside and outside the hole. To generate more variation for augmentation, one or more embodiments apply random dilation and erosion on the input mask 510 (e.g., binary mask), and apply random gaussian blurring on the input mask 510 to generate soft mask before composition to mimic the blurred boundary. In some cases, to mimic more severe seam mismatch scenarios, CMGAN inpainting is applied on the boundary so that the augmented image 520 has slightly different content on the boundary.

In an embodiment, image generation model 500 generates, using generator network 525, preliminary latent code 530 based on augmented image 520. The generator network 525 includes a pre-trained latent encoder which encodes the augmented image 520. In some cases, generator network 525 includes a latent diffusion model. When training decoder network 550 at training time, parameters of generator network 525 are frozen (i.e., not updated).

In an embodiment, image generation model 500 performs latent code augmentation (via latent domain augmentation component 535) to further augment the preliminary latent code 530. In an embodiment, image generation model 500 includes a pre-trained diffusion model that generates a latent code (i.e., preliminary latent code 530). In some examples, random Gaussian noise is added to the latent code to mimic the corruption of latent code introduced due to diffusion inference.

In some examples, CMGANSR and GigaGAN decoder models are used to train decoder network 550 of image generation model 500. In some examples, the decoder network 550 is trained using a GAN loss, a perceptual loss, a pixel L1 loss, or any combination thereof. Training the decoder network 550 includes a process of computing a GAN loss and updating parameters of decoder network 550 based on the GAN loss. In some examples, training the decoder network 550 includes computing a reconstruction loss and updating parameters of decoder network 550 based on the reconstruction loss. In some examples, training the decoder network 550 includes computing a perceptual loss and updating parameters of decoder network 550 based on the perceptual loss. In some examples, training the decoder network 550 includes computing a pixel L1 loss and updating parameters of decoder network 550 based on the pixel L1 loss.

In some embodiments, a GAN includes a generator network (e.g., generator network 525) and a discriminator network. The generator network generates candidates while the discriminator network evaluates them. The generator network learns to map from a latent space to a data distribution of interest, while the discriminator network distinguishes candidates produced by the generator from the true data distribution. The generator network's training objective is to increase the error rate of the discriminator network, i.e., to produce novel candidates that the discriminator network classifies as real.

Image generation model 500 is an example of, or includes aspects of, the corresponding element described with reference to FIGS. 4 and 6. Generator network 525 is an example of, or includes aspects of, the corresponding element described with reference to FIGS. 4 and 12. Decoder network 550 is an example of, or includes aspects of, the corresponding element described with reference to FIG. 4.

FIG. 6 shows an example of a GAN model according to aspects of the present disclosure. The example shown includes image generation model 600, image input 605, encoder 610, decoder 615, random style code 620, global feature code 625, style code 630, and output 635. Image generation model 600 is an example of, or includes aspects of, the corresponding element described with reference to FIGS. 4 and 5.

FIG. 6 illustrates an example architecture of a cascaded modulation inpainting neural network in accordance with one or more embodiments of the present disclosure. As illustrated, the cascaded modulation inpainting neural network (i.e., image generation model 600) includes an encoder 610 and a decoder 615. In particular, the encoder 610 includes a set of convolutional layers at different scales/resolutions. The image inpainting system feeds the image input 605 (e.g., an encoding of the digital image) into the first convolutional layer of encoder 610 to generate an encoded feature vector at a higher scale (e.g., lower resolution). The second convolutional layer of encoder 610 processes the encoded feature vector at the higher scale (lower resolution) and generates an additional encoded feature vector (at another higher scale/lower resolution). The image inpainting system iteratively generates these encoded feature vectors until reaching the final/highest scale convolutional layer of encoder 610 and generating a final encoded feature vector representation of the digital image.

The image inpainting system applies a neural network layer (e.g., a fully connected layer) to the final encoded feature vector to generate a style code 630 (e.g., a style vector). In addition, the image inpainting system generates the global feature code by combining the style code 630 with a random style code 620. In particular, the image inpainting system generates the random style code 620 by utilizing a neural network layer (e.g., a multi-layer perceptron) to process an input noise vector. The neural network layer maps the input noise vector to a random style code 620. The image inpainting system combines (e.g., concatenates, adds, or multiplies) the random style code 620 with the style code 630 to generate the global feature code 625. Although FIG. 6 illustrates a particular approach to generate the global feature code 625, the image inpainting system can utilize a variety of different approaches to generate a global feature code that represents encoded feature vectors of the encoder 610 (e.g., without the style code 630 and/or the random style code 620).

FIG. 7 shows an example of a guided diffusion model according to aspects of the present disclosure. The guided latent diffusion model 700 depicted in FIG. 7 is an example of, or includes aspects of, the corresponding element (i.e., generator network 430) described with reference to FIG. 4.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 700 may take an original image 705 in a pixel space 710 as input and apply and image encoder 715 to convert original image 705 into original image features 720 in a latent space 725. Then, a forward diffusion process 730 gradually adds noise to the original image features 720 to obtain noisy features 735 (also in latent space 725) at various noise levels.

Next, a reverse diffusion process 740 (e.g., a U-Net ANN) gradually removes the noise from the noisy features 735 at the various noise levels to obtain denoised image features 745 in latent space 725. In some examples, the denoised image features 745 are compared to the original image features 720 at each of the various noise levels, and parameters of the reverse diffusion process 740 of the diffusion model are updated based on the comparison. Finally, an image decoder 750 decodes the denoised image features 745 to obtain an output image 755 in pixel space 710. In some cases, an output image 755 is created at each of the various noise levels. The output image 755 can be compared to the original image 705 to train the reverse diffusion process 740.

In some cases, image encoder 715 and image decoder 750 are pre-trained prior to training the reverse diffusion process 740. In some examples, image encoder 715 and image decoder 750 are trained jointly, or the image encoder 715 and image decoder 750 and fine-tuned jointly with the reverse diffusion process 740.

The reverse diffusion process 740 can also be guided based on a text prompt 760, or another guidance prompt, such as an image, a layout, a segmentation map, etc. The text prompt 760 can be encoded using a text encoder 765 (e.g., a multimodal encoder) to obtain guidance features 770 in guidance space 775. The guidance features 770 can be combined with the noisy features 735 at one or more layers of the reverse diffusion process 740 to ensure that the output image 755 includes content described by the text prompt 760. For example, guidance features 770 can be combined with the noisy features 735 using a cross-attention block within the reverse diffusion process 740.

In FIGS. 4-7, an apparatus, system, and method for image processing are described. One or more embodiments of the apparatus, system, and method include a memory component; a processing device coupled to the memory component, the processing device configured to perform operations comprising: obtaining an input image and an input mask, wherein the input image depicts a scene and the input mask indicates an inpainting region of the input image; generating, using a generator network of an image generation model, a latent code based on the input image and the input mask, wherein the latent code includes synthesized content in the inpainting region; and generating, using a decoder network of the image generation model, a synthetic image based on the latent code and the input image, wherein the synthetic image depicts the scene from the input image outside the inpainting region and includes the synthesized content within the inpainting region, and wherein the synthetic image comprises a seamless transition across a boundary of the inpainting region.

In some examples, the generator network comprises a latent diffusion model. In some examples, the decoder network comprises a generative adversarial network (GAN). Some examples of the apparatus, system, and method further include generating a masked image based on the input image and the input mask, wherein the synthetic image is generated based on the masked image. In some examples, the image generation model is trained to generate the synthetic image with the seamless transition based on a training latent code having a seam artifact.

### Training and Evaluation

FIG. 8 shows an example of a method 800 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains a training set including a training image. In some cases, the operations of this step refer to, or may be performed by, a training component as described with reference to FIGS. 4 and 13. In some cases, obtaining a training set can include creating training data for training a machine learning model (e.g., an image generation model). In some cases, the system obtains a pre-existing training set.

At operation 810, the system generates a training latent code representing the training image with a seam artifact. In some cases, the operations of this step refer to, or may be performed by, a training component as described with reference to FIGS. 4 and 13.

In some examples, the system obtains a training set including an input image and an input mask. Obtaining a training set includes a process of creating the training set by obtaining a preliminary image and applying color augmentation, erosion, dilation, blurring, or a combination thereof, to the preliminary image to obtain the input image. The system encodes the input image to obtain a latent code. The system augments the latent code by adding a distortion to obtain an augmented latent code.

In some cases, the preliminary image or the input image may be referred to as a training image. The latent code or the augmented latent code may be referred to as a training latent code.

In some examples, the distortion includes random noise being applied to a latent code. In some examples, random Gaussian noise is added on the latent code to simulate the corruption of latent code due to diffusion inference process.

A synthetic image is generated by decoding the augmented latent code. The synthetic image includes an inpainting region that is distorted in comparison to the rest of the image. The difference between this inpainting region and the rest of the image results in a seam on the boundary (or edges) of the inpainting region. In some cases, the training set includes training latent codes having such a seam artifact.

At operation 815, the system trains, using the training set and the training latent code, an image generation model to generate a synthetic image without the seam artifact. In some cases, the operations of this step refer to, or may be performed by, a training component as described with reference to FIGS. 4 and 13.

In some embodiments, the system trains, using the training set, a decoder network of the image generation model to decode the augmented latent code based on the input image and the input mask. In some examples, a generative adversarial network (GAN) loss, a perceptual loss, a reconstruction loss, and a pixel L1 loss are used to train the decoder network.

A GAN is an artificial neural network in which two neural networks (e.g., a generator network and a discriminator network) are trained based on a contest with each other. For example, the generator network learns to generate a candidate by mapping information from a latent space to a data distribution of interest, while the discriminator network distinguishes the candidate produced by the generator network from a true data distribution of the data distribution of interest. The generator's training objective is to increase an error rate of the discriminator network by producing novel candidates that the discriminator network classifies as “real” (e.g., belonging to the true data distribution).

Therefore, given a training set, the GAN learns to generate new data with similar properties as the training set. For example, a GAN trained on photographs can generate new images that look authentic to a human observer. GANs may be used in conjunction with supervised learning, semi-supervised learning, unsupervised learning, and reinforcement learning.

In some examples, GAN is trained using a training set of latent codes having a seam artifact. The generator learns to generate a synthetic image based on the latent code but without the seam represented by the latent code. The discriminator is trained to identify the target image (i.e. the preliminary image) when selecting between the preliminary image and the synthetic image. As the generator learns to generate seamless synthetic images, the error rate of the discriminator increases as it becomes more difficult to distinguish the preliminary image from the synthetic image. An increasing error rate of the discriminator indicates the generator's ability to remove the seam artifact from the latent code.

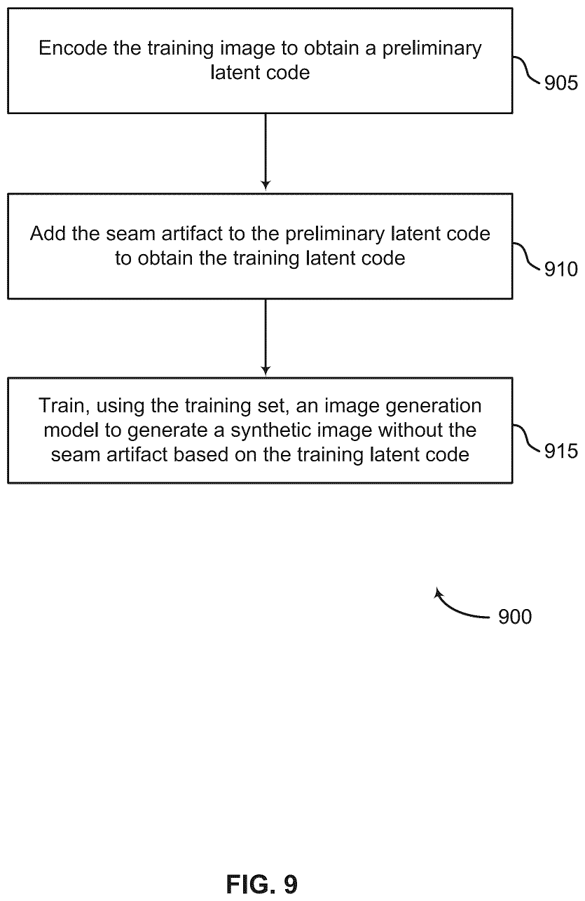

FIG. 9 shows an example of a method 900 for training an image generation model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 905, the system encodes a training image to obtain a preliminary latent code. In some cases, the operations of this step refer to, or may be performed by, a training component as described with reference to FIGS. 4 and 13. In some cases, a training image and a mask are encoded to obtain a preliminary latent code using a trained image encoder. In some cases, the training image is augmented to obtain an augmented image first (i.e., image domain augmentation) as described with reference to FIG. 5.

At operation 910, the system adds the seam artifact to the preliminary latent code to obtain the training latent code. In some cases, the operations of this step refer to, or may be performed by, a training component as described with reference to FIGS. 4 and 13. In some examples, a seam artifact is added to the preliminary latent code by manipulating a masked region of an input image such that the pixels on the boundary of the inpainting area are different than the pixels of non-inpainting/surrounding area (e.g. different coloring, blurring, etc). In some cases, the training latent code may be referred to as an augmented latent code, which is different from the preliminary latent code.

At operation 915, the system trains, using the training set, an image generation model to generate a synthetic image without the seam artifact based on the training latent code. In some cases, the operations of this step refer to, or may be performed by, a training component as described with reference to FIGS. 4 and 13. In some cases, a decoder network of the image generation model is trained using a GAN loss.

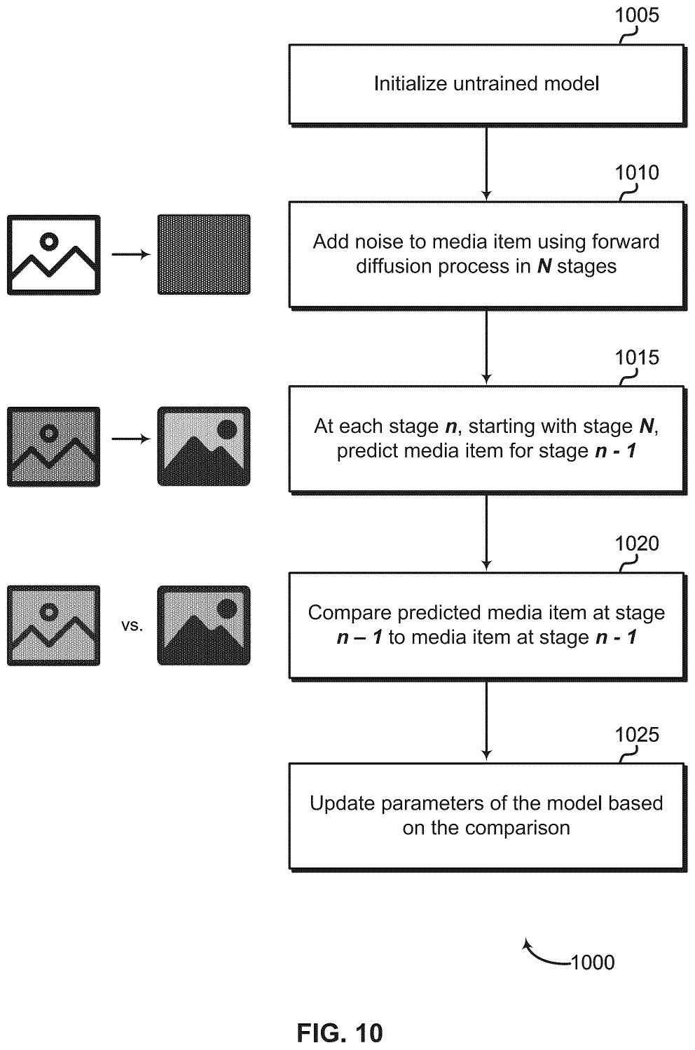

FIG. 10 shows an example of a method 1000 for training a diffusion model according to aspects of the present disclosure. In some embodiments, the method 1000 describes an operation of the training component 445 described for configuring the image generation model 425 as described with reference to FIG. 4. The method 1000 represents an example for training a reverse diffusion process as described above with reference to FIG. 7. In some examples, these operations are performed by a system including a processor executing a set of codes to control functional elements of an apparatus, such as the guided latent diffusion model described in FIG. 7.

Additionally or alternatively, certain processes of method 1000 may be performed using special-purpose hardware. Generally, these operations are performed according to the methods and processes described in accordance with aspects of the present disclosure. In some cases, the operations described herein are composed of various substeps or are performed in conjunction with other operations.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1015, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1020, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1025, the system updates parameters of the model based on the comparison. For example, parameters of a U-Net may be updated using gradient descent. Time-dependent parameters of the Gaussian transitions can also be learned.

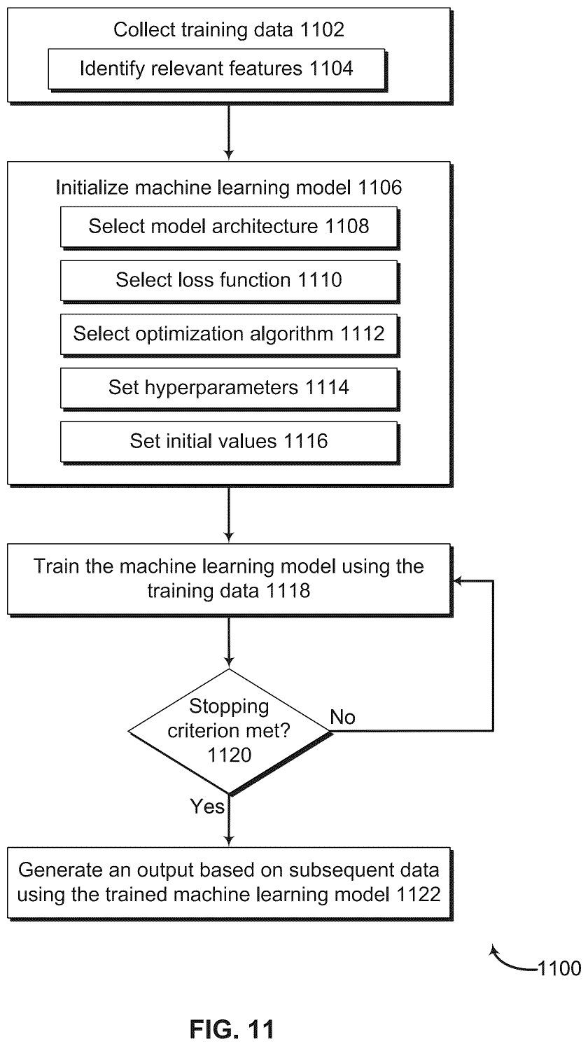

FIG. 11 shows an example of a step-by-step procedure 1100 for training a machine learning model according to aspects of the present disclosure. FIG. 11 shows a flow diagram depicting an algorithm as a step-by-step procedure 1100 in an example implementation of operations performable for training a machine-learning model. In some embodiments, the procedure 1100 describes an operation of the training component 445 described for configuring the image generation model 425 as described with reference to FIG. 4. The procedure 1100 provides one or more examples of generating training data, use of the training data to train a machine learning model, and use of the trained machine learning model to perform a task.

To begin in this example, a machine-learning system collects training data (block 1102) to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (1112) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1114) examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore, once trained is configured to perform that task based on subsequent data received as an input and processed by the machine-learning model.

FIG. 12 shows an example of a method for training a GAN according to aspects of the present disclosure. The example shown includes sampling operation 1200, generator network 1205, and discriminator network 1210. Generator network 1205 is an example of, or includes aspects of, the corresponding element described with reference to FIGS. 4 and 5. Discriminator network 1210 is an example of, or includes aspects of, the corresponding element described with reference to FIG. 13.

A GAN includes a generator network 1205 and a discriminator network 1210. The generator network 1205 generates candidates while the discriminator network 1210 evaluates them. The generator network 1205 learns to map from a latent space to a data distribution of interest, while the discriminator network 1210 distinguishes candidates produced by the generator from the true data distribution. The generator network's training objective is to increase the error rate of the discriminator network 1210, e.g., to produce novel candidates that the discriminator network 1210 classifies as real. In training, the generator network 1205 generates false data, and the discriminator network 1210 learns the false data.

Referring to FIG. 12, at sampling operation 1200, sample (e.g., real data) is generated from real images. The sample generated from the real images is the first input to discriminator network 1210. Discriminator network 1210 uses the real data as positive examples during training. In some embodiments, the operations of this step refer to, or may be performed by, a training component as described with reference to FIG. 4.

According to an embodiment, generator network 1205 receives random input and generates a sample (e.g., false data). The sample generated by generator network 1205 is the second input to the discriminator network 1210. Discriminator network 1210 uses the false data as negative examples during training.

In discriminator training, generator network 1205 is not trained. The weights of the generator network 1205 remain constant while generator network 1205 generates examples (e.g., negative examples) for discriminator network 1210. In some embodiments, discriminator network 1210 is trained based on a generator loss. First, discriminator network 1210 classifies the real data and the false data generated by generator network 1205. Then, the discriminator loss is used to penalize discriminator network 1210 for misclassifying a real data as false or a false data as real. Next, discriminator network 1210 updates the weights of discriminator network 1210 through backpropagation from the discriminator loss through discriminator network 1210.

GAN training proceeds in alternating periods. For example, discriminator network 1210 is trained for one or more epochs and generator network 1205 is trained for one or more epochs. The training component 445 (as described in FIG. 4) continues to train generator network 1205 and discriminator network 1210 in such a way.

FIG. 13 shows an example of a method for training a GAN according to aspects of the present disclosure. The example shown includes training process 1300, image generation network 1305, text encoder network 1310, discriminator network 1315, training component 1320, predicted image 1325, conditioning vector 1330, image embedding 1335, conditioning embedding 1340, discriminator prediction 1345, and loss function 1350. Discriminator network 1315 is an example of, or includes aspects of, the corresponding element described with reference to FIG. 12. Training component 1320 is an example of, or includes aspects of, the corresponding element described with reference to FIG. 4. The example shown includes training an image generation network (a generator) and a discriminator network (a discriminator).

Image generation network 1305 generates predicted image 1325 using a low-resolution input image. Similarly, text encoder network 1310 generates conditioning vector 1330 based on a text prompt. Image generation network 1305 and text encoder network 1310 are examples of, or includes aspects of, the corresponding element described with reference to FIGS. 4-7.

According to an embodiment of the present disclosure, the discriminator network 1315 includes a StyleGAN discriminator. Self-attention layers are added to the StyleGAN discriminator without conditioning. In some cases, a modified version of the discriminator network 1315 (e.g. a projection-based discriminator network) incorporates conditioning. Discriminator network 1315 is an example of, or includes aspects of, the corresponding element described with reference to FIG. 4-6.

According to an embodiment, discriminator network 1315 (also denoted as D(⋅,⋅)) includes two branches. A first branch is a convolutional branch ϕ(⋅) that receives an RGB image x and generates an image embedding 1635 of the RGB image x (image embedding is denoted as ϕ(x)). A second branch is a conditioning branch denoted as ψ(⋅). The conditioning branch receives conditioning vector 1330 (the conditioning vector is denoted as c) based on the text prompt. The conditioning branch generates conditioning embedding 1340 (conditioning embedding is also denoted as ψ(c)). Accordingly, discriminator prediction 1345 is the dot product of the two branches:

$$D ( x , c ) = ∅ {( x )}^{T} ψ ( c ) \qquad ( 1 )$$

Training component 1320 calculates loss function 1350 based on discriminator prediction 1345 during training process 1300. In some examples, loss function 1350 includes a non-saturating GAN loss. Training component 1320 is an example of, or includes aspects of, the corresponding element described with reference to FIG. 4. The machine learning model is trained using GAN loss as follows:

$${ℒ}_{GAN , real} = {E}_{x , c \sim {p}_{data}} [ log ( 1 + exp ( - ∅ {( x )}^{T} ψ ( c ) ) ] \qquad ( 2 )$$

$${ℒ}_{GAN , fake} = {E}_{x , c \sim {p}_{fake}} [ log ( 1 + exp ( ∅ {( x )}^{T} ψ ( c ) ) ] \qquad ( 3 )$$

In some embodiments, discriminator prediction 1345 measures the alignment of the image x with the conditioning c. In some cases, a decision can be made without considering the conditioning c by collapsing conditioning embedding 1340 (ψ(c)) to the same constant irrespective of c. Discriminator network 1315 utilizes conditioning by matching xᵢ with an unrelated condition c_{j≠i} taken from another sample in the minibatch

$${\{ ( {x}_{i} , {C}_{i} ) \}}_{i}^{N} ,$$

and presents the matching as fake images. The training component 1320 computes a mixing loss based on the image embedding and the mixed conditioning embedding, where the image generation network 1305 is trained based on the mixing loss. The mixing loss is referred to as [symbol] _{mixaug} formulated as follows:

$${ℒ}_{mixaug} = {E}_{\{ ( {x}_{i} , {c}_{i} ) \} \sim {p}_{data}} [ \frac{1}{N - 1} {\sum }_{j \neq i} log ( 1 + exp ( ϕ {( {x}_{i} )}^{T} ψ ( {c}_{j} ) ) ) ] \qquad ( 4 )$$

According to some embodiments, equation (4) above relates to the repulsive force of contrastive learning which encourages the embeddings to be uniformly spread across the space.

$${E}_{{\{ ( {x}_{i} , {c}_{i} ) \}}_{i}} [ - log ( \frac{{e}^{{ϕ ( {x}_{i} )}^{T} ψ ( {c}_{i} )}}{{e}^{{ϕ ( {x}_{i} )}^{T} ψ ( {c}_{i} )} + {\sum }_{j \neq i} {e}^{{ϕ ( {x}_{i} )}^{T} ψ ( {c}_{j} )}} ) ] = {E}_{{\{ ( {x}_{i} , {c}_{i} ) \}}_{i}} log ( 1 + {\sum }_{j \neq i} exp ( {\underbrace{ϕ {( {x}_{i} )}^{T} ψ ( {c}_{j} )}}_{repulsive} - {\underbrace{ϕ {( {x}_{i} )}^{T} ψ ( {c}_{i} )}}_{attractive} ) ) \qquad ( 5 )$$

The two methods minimize similarity between unrelated image x and conditioning c, but the methods differ in that the logit of [symbol] _{mixaug} in Equation (9) is not pooled with other pairs inside the logarithm. In some cases, the formulation encourages stability and is not affected by hard-negatives of the batch. Accordingly, discriminator network 1315 generates an embedding based on the convolutions and input conditioning to train the image generation network 1305 that predicts a high-resolution image.

In FIGS. 8-13, a method, apparatus, non-transitory computer readable medium, and system for image processing are described. One or more embodiments of the method, apparatus, non-transitory computer readable medium, and system include obtaining a training set including a training latent code having a seam artifact and training, using the training set, an image generation model to generate a synthetic image without the seam artifact based on the training latent code.

Some examples of the method, apparatus, non-transitory computer readable medium, and system further include encoding an image to obtain a preliminary latent code. Some examples further include adding the seam artifact to the preliminary latent code to obtain the training latent code.

Some examples of the method, apparatus, non-transitory computer readable medium, and system further include adding the seam artifact to an image to obtain an augmented image. Some examples further include encoding the augmented image to obtain the training latent code.

In some examples, the seam artifact comprises a random noise distortion, color augmentation, erosion, dilation, blurring, or any combination thereof. Some examples of the method, apparatus, non-transitory computer readable medium, and system further include obtaining a mask, wherein the seam artifact is added at a boundary region of the mask.

Some examples of the method, apparatus, non-transitory computer readable medium, and system further include computing a generative adversarial network (GAN) loss. Some examples further include updating parameters of the image generation model based on the GAN loss.

Some examples of the method, apparatus, non-transitory computer readable medium, and system further include computing a reconstruction loss. Some examples further include updating parameters of the image generation model based on the reconstruction loss.

Some examples of the method, apparatus, non-transitory computer readable medium, and system further include computing a perceptual loss. Some examples further include updating parameters of the image generation model based on the perceptual loss.

Some examples of the method, apparatus, non-transitory computer readable medium, and system further include freezing parameters of a generator network of the image generation model while training a decoder network of the image generation model.

FIG. 14 shows an example of a computing device 1400 for image processing according to aspects of the present disclosure. The computing device 1400 may be an example of the image processing apparatus 400 described with reference to FIG. 4. In one aspect, computing device 1400 includes processor(s) 1405, memory subsystem 1410, communication interface 1415, I/O interface 1420, user interface component(s) 1425, and channel 1430.

In some embodiments, computing device 1400 is an example of, or includes aspects of, the image generation model 425 of FIG. 4. In some embodiments, computing device 1400 includes one or more processors 1405 that can execute instructions stored in memory subsystem 1410 to perform media generation.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

Performance of apparatus, systems and methods of the present disclosure have been evaluated, and results indicate embodiments of the present disclosure have obtained increased performance over existing technology. Example experiments demonstrate that the image processing system described in embodiments of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input image and an input mask, wherein the input image depicts a scene and the input mask indicates an inpainting region of the input image;
generating, using a generator network of an image generation model, a latent code based on the input image and the input mask, wherein the latent code includes synthesized content in the inpainting region; and
generating, using a decoder network of the image generation model, a synthetic image based on the latent code and the input image, wherein the synthetic image depicts the scene from the input image outside the inpainting region and includes the synthesized content within the inpainting region, and wherein the synthetic image comprises a seamless transition across a boundary of the inpainting region.

2. The method of claim 1, further comprising:
selecting an inpainting mode, wherein the synthetic image is generated based on the inpainting mode.

3. The method of claim 1, further comprising:
obtaining an input prompt, wherein the synthesized content is based on the input prompt.

4. The method of claim 1, wherein generating the latent code comprises:
obtaining a noise map;
encoding the input image to obtain an input encoding; and
denoising the noise map based on the input encoding.

5. The method of claim 1, wherein:
the image generation model is trained for an inpainting task using a training set including a training latent code representing a seam artifact.

6. The method of claim 1, further comprising:
generating a masked image based on the input image and the input mask, wherein the synthetic image is generated based on the masked image.

7. A method of training an image generation model, the method comprising:
obtaining a training set including a training image;
generating a training latent code representing the training image with a seam artifact; and
training, using the training set and the training latent code, an image generation model to generate a synthetic image without the seam artifact.

8. The method of claim 7, wherein generating the training latent code comprises:
encoding the training image to obtain a preliminary latent code; and
adding the seam artifact to the preliminary latent code to obtain the training latent code.

9. The method of claim 7, wherein generating the training latent code comprises:
adding the seam artifact to an image to obtain an augmented image; and
encoding the augmented image to obtain the training latent code.

10. The method of claim 7, wherein:
the seam artifact comprises a random noise distortion, color augmentation, erosion, dilation, blurring, or any combination thereof.

11. The method of claim 7, further comprising:
obtaining a mask, wherein the seam artifact is added at a boundary region of the mask.

12. The method of claim 7, wherein training the image generation model comprises:
computing a generative adversarial network (GAN) loss; and
updating parameters of the image generation model based on the GAN loss.

13. The method of claim 7, wherein training the image generation model comprises:
computing a reconstruction loss; and
updating parameters of the image generation model based on the reconstruction loss.

14. The method of claim 7, wherein training the image generation model comprises:
computing a perceptual loss; and
updating parameters of the image generation model based on the perceptual loss.

15. The method of claim 7, wherein training the image generation model comprises:
freezing parameters of a generator network of the image generation model while training a decoder network of the image generation model.

16. A system comprising:
a memory component; and
a processing device coupled to the memory component, the processing device configured to perform operations comprising:
obtaining an input image and an input mask, wherein the input image depicts a scene and the input mask indicates an inpainting region of the input image;
generating, using a generator network of an image generation model, a latent code based on the input image and the input mask, wherein the latent code includes synthesized content in the inpainting region; and
generating, using a decoder network of the image generation model, a synthetic image based on the latent code and the input image, wherein the synthetic image depicts the scene from the input image outside the inpainting region and includes the synthesized content within the inpainting region, and wherein the synthetic image comprises a seamless transition across a boundary of the inpainting region.

17. The system of claim 16, wherein:
the generator network comprises a latent diffusion model.

18. The system of claim 16, wherein:
the decoder network comprises a generative adversarial network (GAN).

19. The system of claim 16, wherein the processing device is further configured to perform operations comprising:
generating a masked image based on the input image and the input mask, wherein the synthetic image is generated based on the masked image.

20. The system of claim 16, wherein:
the image generation model is trained to generate the synthetic image with the seamless transition based on a training latent code having a seam artifact.
